(19) United States
(12) Patent Application Publication
(10) Pub. No.: US 2013/0331215 A1
(43) Pub. Date: Dec. 12, 2013

(54) Pulley With Lateral Annular Bearing Retainers

(71) Applicant: Dan Hewitt, New Berlin, WI (US)

(72) Inventor: Dan Hewitt, New Berlin, WI (US)

(21) Appl. No.: 13/491,728

(22) Filed: Jun. 8, 2012

(51) Int. Cl. F16H 55/36

(52) U.S. Cl. 474/174

(57) ABSTRACT

A pulley including a disc defining an annular circumferential groove and also defining a central opening extending axially through the disc. A bearing assembly is disposed in the bearing opening and secured to the disc with a bearing retainer coupled to opposing faces of the disc and securing the bearing assembly in the disc with a plurality of fasteners extending through each of the bearing retainers and each face of the disc fixing the bearing assembly in place without deforming the bearing assembly.

### BACKGROUND OF THE INVENTION

### Field of the Invention

This invention relates to pulleys, and more particularly to a pulley with a separate bearing assembly secured to the pulley with annular bearing retainers.

It is known that pulleys, such as idler pulleys, have a bearing securely affixed to the pulley. The existing methods of assembling a bearing into a pulley utilize a variety of methods. For example, a two piece pulley is assembled around the bearing wherein the bearing is captured within the two bearing pieces. A disadvantage of such assembly is that there is a groove or seam extending through the bearing belt receiving groove. Such seam in the pulley groove can cause undue wear on a belt associated with such pulley.

Another method of assembling a bearing into a pulley is to force the bearing into the pulley. The force applied to the bearing, to have a friction fit, tends to distort the metal of the bearing and particularly the bearing race. Such a condition may cause the bearing to operate in an unbalanced condition or to bind ball bearings moving through the race.

Another method of securing or assembling a bearing into a pulley is to use a retainer apparatus and weld the retainer apparatus to the pulley to secure the bearing. Such method can damage the bearing because of the heat of welding and it is also typically more expensive than a non-welding procedure.

The apparatus of the present disclosure must also be of construction which is both durable and long lasting, and it should also require little or no maintenance to be provided by the user throughout its operating lifetime. In order to enhance the market appeal of the apparatus of the present disclosure, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present disclosure.

There is disclosed a pulley that includes a disc composed of a formed unitary material. Such material can be a metal or a polymer and is formed as a single piece. In other words, there is no seam extending circumferentially on the pulley. The disc defines an annular groove having radially extending spaced apart sidewalls with the groove extending on and along a circumferential edge surface of the disc. The disc defines a central bearing opening extending axially through each side face of the disc. A bearing assembly is configured for disposition in the bearing opening with opposite side portions of the bearing assembly extending axially beyond the respective face of the disc.

The bearing assembly is retained in the disc by a pair of bearing retainers. Each bearing retainer includes a flange portion configured to allow the bearing retainer to contact the portion of the bearing assembly that extends axially beyond the respective face of the disc. The flange portion of the bearing retainer also is configured and positioned on each face of the disc and is in contact with the portion of the bearing assembly. Each bearing retainer defines a central opening that corresponds and aligns with an opening in the bearing assembly and configured to receive an axel about which the pulley rotates.

The bearing retainers are secured to the disc with a plurality of fasteners with each fastener extending through each of the bearing retainers and each face of the disc fixing the bearing assembly in place, without deforming the bearing assembly. The bearing assembly is sandwiched between the two bearing retainers within the central bearing opening of the disc. The configuration of the bearing assembly and the diameter of the central bearing opening are dimensioned to provide a slip fit without distorting the bearing assembly. The two bearing retainers, when coupled to the disc secure the bearing assembly in the disc so that the bearing assembly and disc will freely rotate when a torque is applied to the disc.

In one embodiment of the pulley, the fasteners used to couple the bearing retainers to each face of the disc are rivets. In another embodiment the fasteners that secure the bearing retainers to the respective faces of the disc are a nut and bolt assembly. The use of rivets or nut and bolt assemblies as the fasteners to secure the bearing assembly in the disc allows for repair or replacement of the bearing assembly without distorting or damaging the disc.

There is also disclosed a method for manufacturing of a pulley. The method includes providing a single piece of material defining a circular disc. The single piece of material can be one of a metal. A continuous annular groove is formed on and along a circumferential edge surface of the disc with the annular groove having a pair of radially extending, spaced apart side walls. In one embodiment the annular groove is formed with a split steel process which does not create a seam in the annular groove. A central bearing opening extending axially through each side face of the disc is formed by any convenient and conventional method such as drilling, milling, or punching.

A bearing assembly is installed into the central bearing opening with a portion of the bearing assembly extending axially beyond the respective face of the disc. The bearing assembly typically includes an outer race having an outer race face and an inner race defining a central opening. Typically a plurality of ball bearings are captured between the outer and inner races and may or may not include a lubricating agent.

A flanged bearing retainer is placed on each side of the disc and positioned to contact the entire portion of the bearing assembly extending beyond the respective face of the disc and contacting the disc face. The bearing retainer also defines a bearing pocket which captures the face of the outer race of the bearing assembly.

The bearing retainer is secured to the disc with a plurality of fasteners. Each of the fasteners extends through each of the bearing retainers in each face of the disc fixing the bearing assembly in place in the central bearing opening of the disc without deforming the bearing assembly. The plurality of fasteners are spaced around the flanged portion of the bearing retainer and equally spaced from each other. In one embodiment the fasteners are rivets and in another embodiment the fasteners are a bolt and nut assembly. When the fasteners are tightened either by deforming the rivets or applying a torque to the nuts and bolts the flanged portions of the bearing retainers are pulled towards each other and towards the disc face to eliminate any air gap between the retainers and the disc.

There is also provided a pulley that includes a disc composed of a formed unitary metal. The unitary metal from which the disc is formed is one of steel, brass, and aluminum. The forming of the disc from a single piece of metal is done with a split-steel process. The disc defines an annular groove having a radially extending spaced apart sidewalls with the groove extending on and along a circumferential edge surface of the disc. The disc defines a central bearing opening extending axially through each side face of the disc.

A bearing assembly is configured for disposition in the bearing opening with the opposite side portions of the bearing assembly extending axially beyond the respective face of the disc.

A bearing retainer including a flanged portion and a bearing pocket is configured to allow the bearing retainer to contact, in the bearing pocket, the portion of the bearing assembly that extends axially beyond the respective face of the disc. The flanged portion of the bearing retainer is positioned on each face of the disc and in contact with the bearing assembly.

A plurality of rivets secures the respective bearing retainer to the disc. Each rivet extends through each of the bearing retainers flanges and each face of the disc fixing the bearing assembly in place, without deforming the bearing assembly.

The apparatus of the present invention is of a construction which is both durable and long lasting, and which will require little or no maintenance to be provided by the user throughout its operating lifetime. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a perspective view illustration of an exemplary embodiment of a formed unitary pulley with a bearing assembly coupled to a disc of the pulley with a bearing retainer fastened to the disc.

FIG. 2 is a plan view illustration of a disk face the pulley illustrated in FIG. 1.

FIG. 3 is a section view of the pulley illustrated in FIG. 2 along the line 3-3.

FIG. 4 is a detail cross-section of a portion of the pulley illustrated in FIG. 3 along the line 4-4, illustrating a rivet type fastener extending through each bearing retainer and each face of the disc to secure the bearing assembly to the disc.

FIG. 5 is an exploded view of the pulley embodiment illustrated in FIG. 1.

### DETAILED DESCRIPTION OF THE EXEMPLARY EMBODIMENTS

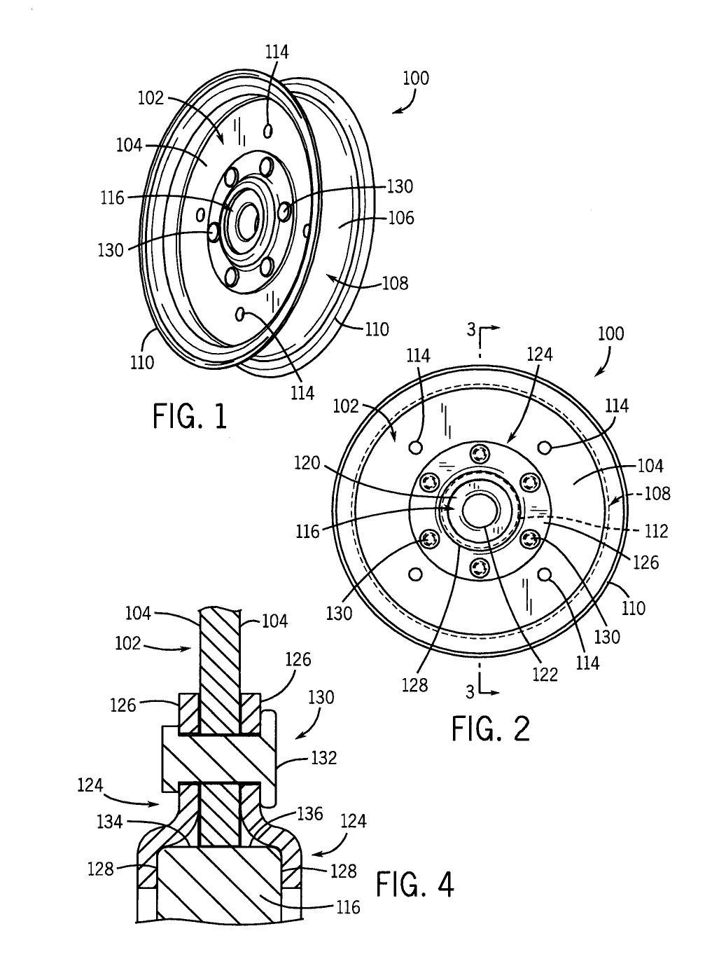

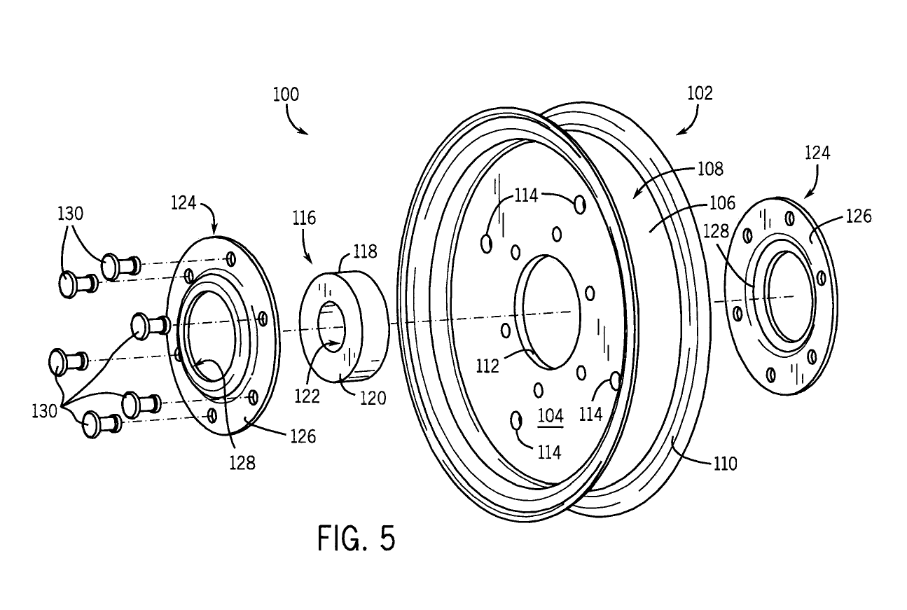

Referring to the FIGS. 1-5, this disclosure describes and illustrates a pulley 100 including flanged bearing retainers 124 configured to enclose the outer annular portion 120 of a bearing assembly 116 disposed in a central opening 112 centered on the disc axial center line 113 in the disc 102 of the pulley 100 without distorting the bearing races 118, 120 of the bearing assembly 116.

FIGS. 1 and 2 illustrate an exemplary embodiment of a pulley 100. The illustrations show one disc face 104 of the illustrated pulley 100 with a bearing retainer 124 securing a bearing assembly 116 in a central bearing opening 112 extending through the center of the pulley 100.

A disc 102 of the pulley 100 is composed of a formed unitary material, for example a polymer or a metal. If the disc 102 is composed of a polymer, it typically is molded as a single piece that defines an annular groove 108 and side walls 110 of the pulley 100 as determined by the manufacturer or user of the pulley 100.

In a preferred embodiment, the disc 102 is composed of a metal, for example steel, brass or aluminum, and more typically from steel. The forming of the pulley from the disc 102 is performed with a split steel process. In that process, a disc blank, which has had various openings formed in the blank (see below), is loaded into a split steel machine that has a knife on one side and a forming tool diametrically opposite the knife. The single piece disc blank is locked into place on the machine and spun to a very high revolution per minute speed while the knife and forming tool move inward towards the edge of the disc blank. The operation of the knife and forming tool split the edge of the disc blank and continue inward forming a pulley groove in a circumferential surface 106 of the disc 102. A split steel machine can be programmed for different size pulleys and different configurations of the annular groove 108 as determined by the manufacturer user. The resulting pulley 100 has a proper belt groove created around the circumferential edge of the disc 102 with the pulley being formed from a single material. As discussed above, conventional pulleys typically are formed with two discs coupled together, for example by welding which creates a seam in the annular groove 108 of the pulley. This present disclosure describes creation of a pulley 100 that has an annular groove 108 without a seam.

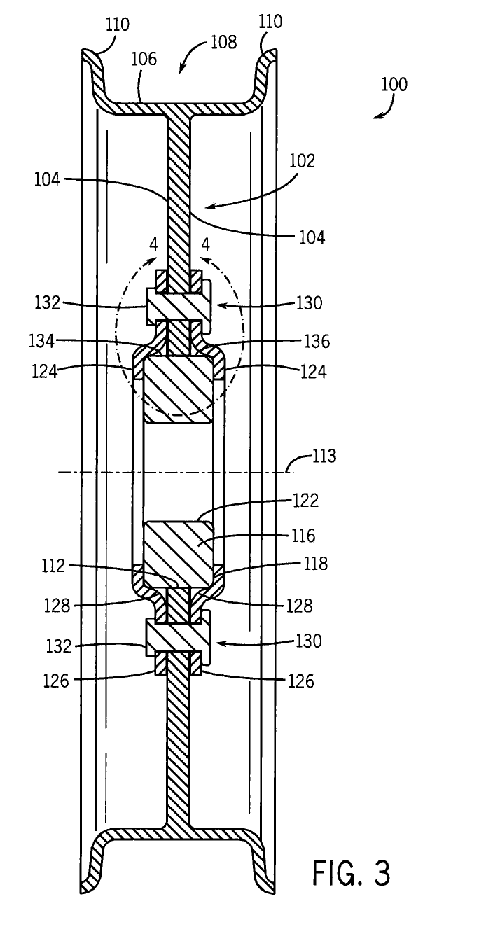

Regardless of the unitary material from which the disc 102 of the pulley 100 is formed, a bearing assembly is installed in the central opening 112 of the pulley 100. The bearing assembly typically includes an outer race 118 including an outer race face 120 and an inner race 122. Typically, between the inner race 122 and the outer race 118 a plurality of ball bearings are captured and may or may not include a lubricating agent. The bearing assembly is typically composed of metal that is appropriate for the intended application of the pulley 100. The bearing assembly 116 is configured for disposition in the bearing opening 112 with a slip fit, with opposite side outer race portions 134, 136 of the bearing assembly 116 extending axially beyond the respective face 104 of the disc 102 of the pulley 100. (See FIGS. 3 and 4).

Bearing retainers 124 secure the bearing assembly 116 in the central bearing opening 112 of the pulley 100. One bearing retainer 124 is on each disc face 104 of the pulley 100. Each bearing retainer 124 includes a flanged portion 126 configured to allow the bearing retainer 124 to contact the outer race portion 134, 136 of the bearing assembly 116 that extends axially beyond the respective face 104 of the disc 102. The bearing retainer 124 further includes a bearing pocket 128 which is configured to allow the bearing retainer 124 to contact, in the bearing pocket 128, the portion 134, 136 of the bearing assembly 116 that extends beyond the respective face of the disc. (See FIGS. 3-5).

Each bearing retainer 124 is positioned on each face 104 of the disc 102 and is in contact with the bearing assembly 116. Each bearing retainer 124 further defines a central opening that corresponds and is co-axial with the central bearing opening 112 defined in the disc of the pulley 100. Such openings are configured to receive an axel about which the pulley 100 will rotate in a given application. A typical application of the disclosed pulley 100 is as an idler pulley associated with the deck of a grass cutting machine.

With the bearing assembly 116 installed in the central bearing opening 112 of the disc 102 a bearing retainer 124 is placed on each side of the disc 102 and positioned to contact the entire portion of the bearing assembly extending beyond the respective face of the disc and contacting the disc face. (See FIGS. 1 and 3). The outer race face 120 of the bearing assembly 116 is disposed in the bearing pocket 128 of the bearing retainer 124. During such assembly, an air gap exists between each bearing retainer 124 and the disc face 104. A plurality of fasteners 130, for example rivets, secure each bearing retainer 124 to the disc 102. Each fastener extends through each of the bearing retainers 124 and each face 104 of the disc 102 fixing the bearing assembly in place in the central bearing opening 112 of the disc 102 without deforming the bearing assembly 116. As the rivets are deformed in a typical riveting operation, the rivets pull the bearing retainers 124 towards each other and against each disc face 104 closing the air gap between the retainers and the disc 102. Such operation secures the bearing assembly 116 to the disc 102 of the pulley 100 without deformation of the bearing assembly 116 which allows the pulley to freely rotate when a torque is applied to the pulley by a belt positioned in the annular groove 108 of the pulley 100.

The preferred embodiment of the pulley 100 utilizes rivets 132 as the fasteners 130. However, it is also contemplated that other fastener means can be used to secure the bearing retainer 124 to the disc 102, for example, adhesives or nuts and bolts. A& nut and bolt assembly can be utilized to secure the bearing retainers 124 to the disc 102 of the pulley to fix the bearing assembly 116 in place in the central bearing opening 112 of the disc 102. For example, a bolt of sufficient length to extend through the retainer 124, and disc 102 and provide threads to secure a nut can be used. The bolt can be a hex-head bolt and the nut can be a lock nut.

Each of the illustrations shows six fasteners 130 being used to secured the bearing retainers 124 to the disc 102. However it should be understood that any number of fasteners 130 can be utilized with the fasteners typically equally spaced about the flanged portion 126 of the bearing retainers 124.

As illustrated in the figures, in addition to the central bearing opening 112 and the several openings in the disc faces 104 configured to receive the fasteners 130, additional disc apertures 114 can be defined in the disc 102 of the pulley 100. The disc 102 is processed to create a central bearing opening 112 in the disc extending axially through each side face 104 of the disc 102. Such central bearing opening 112 can be created by machining, such as a mill, a drill press, or punch. Such disc apertures 114 can be machined in the pulley 100 before the split steel machining process is performed. The disc apertures 114 function as drain holes for example when the pulley 100 is in a horizontal position. Disc apertures 114 can also be utilized to reduce weight of the pulley. It should be understood that the disc apertures 114 can be of any suitable predetermined geometry, for example circular, trapezoidal, rectangular, as determined by the user or manufacturer of the pulley 100 considering the anticipated application of the pulley 100.

When the pulley is formed as described above the pulley 100 is removed from the split steel machinery with the disc 102 defining an annular groove 108 having radially extending spaced apart side walls 110 with the groove 108 extending on and along a circumferential edge surface 106 of the disc 102.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present mechanism has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the mechanism as described herein may be made, none of which depart from the spirit or scope of the present disclosure. The particular embodiments and applications were chosen and described to provide the best illustration of the principles of the mechanism and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A pulley comprising:
a disc composed of a formed unitary material, the disc defining an annular groove having radially extending spaced apart side walls with the groove extending on and along a circumferential edge surface of the disc, with the disc defining a central bearing opening extending axially through each side face of the disc;
a bearing assembly configured for disposition in the bearing opening with opposite side portions of the bearing assembly extending axially beyond the respective face of the disc;
a bearing retainer including a flanged portion configured to allow the bearing retainer to contact the portion of the bearing assembly that extends axially beyond the respective face of the disc, with the bearing retainer positioned on each face of the disc and in contact with a portion of the bearing assembly; and
a plurality of fasteners with each fastener extending through each of the bearing retainers and each face of the disc fixing the bearing assembly in place, without deforming the bearing assembly.

2. The pulley of claim 1, wherein the fasteners are rivets.

3. The pulley of claim 1, wherein the fasteners are a nut and bolt assembly.

4. The pulley of claim 1, wherein the unitary material is a metal.

5. A method for manufacturing a pulley comprising:
providing a single piece of material defining a circular disc;
forming a continuous annular groove having a pair of radially extending, spaced apart side walls, with the groove extending on and along a circumferential edge surface of the disc;
forming a central bearing opening extending axially through each side face of the disc;
installing a bearing assembly into the central bearing opening with a portion of the bearing assembly extending axially beyond the respective face of the disc;
placing a flanged bearing retainer on each side of the disc and positioned to contact the entire portion of the bearing assembly extending beyond the respective face of the disc and contacting the disc face; and
securing each bearing retainer to the disc with a plurality of fasteners, each extending through each of the bearing retainers and each face of the disc fixing the bearing assembly in place in the central bearing opening of the disc without deforming the bearing assembly.

6. The method of claim 1, wherein the fasteners are rivets.

7. The method of claim 1, wherein the fasteners are a nut and bolt assembly.

8. The pulley of claim 1, wherein the single piece of material of a metal.

9. A pulley comprising:
a disc composed of a formed unitary metal, the disc defining an annular groove having radially extending spaced apart side walls with the groove extending on and along a circumferential edge surface of the disc, with the disc defining a central bearing opening extending axially through each side face of the disc;
a bearing assembly configured for disposition in the bearing opening with opposite side portions of the bearing assembly extending axially beyond the respective face of the disc;
a bearing retainer including a flanged portion and a bearing pocket configured to allow the bearing retainer to contact, in the bearing pocket, the portion of the bearing assembly that extends axially beyond the respective face of the disc, with the flanged portion of the bearing retainer positioned on each face of the disc and in contact with a portion of the bearing assembly; and
a plurality of rivets with each rivet extending through each of the bearing retainers flanges and each face of the disc fixing the bearing assembly in place, without deforming the bearing assembly.

10. The pulley of claim 9, wherein the unitary metal is one of steel, brass, and aluminum.
